(19) United States
(12) Patent Application Publication
(10) Pub. No.: US 2009/0125963 A1
(43) Pub. Date: May 14, 2009

(54) System for establishing a connection between a service centre and a plurality of devices for the reception of television signal

(75) Inventors: Paolo D'amato Damato, Roma (IT); Roberto Dini, None (IT); Massimo Mancin, Collegno (IT)

Correspondence Address: OBLON, SPIVAK, MCCLELLAND MAIER & NEUSTADT, P.C., 1940 DUKE STREET, ALEXANDRIA, VA, 22314, US

(73) Assignee: S.I.SV.EL. S.P.A., None (TO) (IT)

(21) Appl. No.: 11/911,780

(22) PCT Filed: Apr. 11, 2006
(86) PCT No.: PCT/IB06/00927

§ 371 Date: Apr. 21, 2008

(30) Foreign Application Priority Data
Apr. 18, 2005 (IT) MI2005A000677

(51) Int. Cl. H04N 7/173

(52) U.S. Cl. 725/118

(57) ABSTRACT

A system for establishing a connection between a service center and a plurality of devices for reception of a television signal, wherein the connection utilizes an electric supply network. The electric supply network is set up as a local area network (LAN) of devices for the reception of the television signal.

The present invention relates to a system for establishing a connection between a service centre and a plurality of devices for the reception of television signal, devices for the reception of a television signal suitable for such a system, and a television set comprising such a device.

The present invention falls within the telecommunications field.

The present invention concerns a system for the interaction between a service centre and a plurality of digital television decoders adapted to execute interactive software applications, hereafter simply referred to as applications, stored in or downloaded on digital decoders, which may be of any nature (digital terrestrial, satellite, cable reception, etc.) in order to allow a bidirectional connection between the users and the service centre as well as the collection of statistical data. One such digital decoder is a particular type of devices for the reception of television signal.

As known, the execution of said applications makes decoders powerful and versatile tools capable of providing not only video/text information of any kind, but also of involving the radio-television users by means of interactive services for many different purposes (taking part in quiz games and television polls, shopping, games, interaction with public bodies, etc.).

At present, interactive decoders employ a modem, which carries out the data exchange with the service centre through the public switched telephone network (PSTN) by using the same frequency range as that used for the normal voice signal; this implies, therefore, the necessity of establishing a connection by dialing a telephone number for every data exchange session, which is clearly a slow, complex and costly operation.

If the user has no digital telephone lines (ISDN) or broad-band systems (ADSL), his/her telephone line will remain busy for the entire duration of the data exchange operation, thus limiting or anyway complicating his/her possibilities of voice communication, and in any case determining extra expenses depending on the length of the operation itself. Monitoring data related to radio-television users' preferences is an operation which is at present largely used for statistical/marketing purposes.

Owing to its complexity and costs of the service, such a monitoring activity (e.g. the one called “Auditel”) can only be carried out on a very limited sample of television-set owners, and the data collected from the dedicated device, owned only by a certain number of selected users, is transmitted to the service centre at a predetermined time over a telephone connection. In general, the devices dedicated to sending this data are external to the television set.

With the above-mentioned means, monitoring a wider audience sample would in any case be particularly complex and costly.

Nowadays the DSL (“Digital Subscriber Line”) technology is available, based on the use of a modem which uses the existing telephone line for transmitting data at high speed, in a frequency range being different from that used for the voice signal, thus not interfering with the normal telephone traffic.

The DSL technology is a good alternative to the traditional technology described above, since it provides a continuous connection, available at all times, while keeping the viewer's telephone channel always free.

However, also the DSL modem uses the fixed telephone network. Therefore, both of the above-mentioned systems oblige the user to connect the decoder to the telephone network, with evident wiring and aesthetic problems. Usually, in fact, the television set in which or close to which the decoder is positioned is far from the telephone socket or even in a different room. Besides, it is apparent that the fixed wiring makes it hard to move the decoder.

Today there are wireless networks such as, for instance, those for digital mobile telephony (e.g. GSM, UMTS, etc.).

In any case, using a mobile telephone line leads to increased service costs, because of the inevitable additional contributions due to the mobile telephony provider.

On the other hand, it is now possible to use a radiofrequency connection between the decoder and a suitable device located within the apartment; such a device can send and receive signals over the telephone network, e.g. through a DSL modem, and communicate with the decoder through electromagnetic waves, by using for example the “IEEE 802.11” Standard. It is however clear that the need for an additional device to be installed in the apartment makes this solution costly and inconvenient.

It is also known that the lines dedicated to the transport of electric energy could also be used as means for transmitting data, by superimposing on the supply current, which in any case is a low-frequency signal (50 Hz or 60 Hz), a data information signal at a much higher frequency (this is the well-known case of the so-called “conveyed wave transmission”).

The use of electric lines as means for data transmitting is known and has been effectively applied to short-distance local networks, such as those inside buildings. Electric lines have been used as a means for data transmission also for the remote automated management of electricity meters, by using slow communication speeds, e.g. as described in the recent Patent Application WO 03/055031.

A second recent contribution to the state of the art is represented by the Patent Application WO 01/47268, which relates to a communication method using the electric network between a particular television decoder, called set top box, and a remote unit fitted with a modem connected to a telephone line; such a solution provides for a point-to-point connection between said devices.

A third recent contribution to the state of the art is represented by the Patent Application WO 02/09428, which relates to a decoder for the management of the so-called Pay-TV, and requires, only hypothetically and without the least technical indication allowing its implementation, the use of the electric distribution network as a secondary communication path whenever the telephone line is unavailable.

Apart from the fact that the above patent application is limited to a very specific case of a decoder used for Pay-TV, said application (later withdrawn) provides no teachings neither about how the electric network is used as data transmission means nor about the connection interactivity between the various digital decoders and the service centre.

The general object of the present invention is to provide a solution which overcomes the drawbacks of the prior art.

This object is achieved through the system for establishing a connection between a service centre and a plurality of devices for the reception of television signal, the devices for the reception of television signal and the television set having the features described in the annexed claims, which form an integral part of the present description. The present invention is based on the idea of using an electric supply network to exchange data with the service centre.

Such data may be carried over electric lines even only for a short distance, to be then extracted at any suitable point of the electric network and forwarded over different networks.

The use of electric lines as means for creating a data transmission LAN (Local Area Network) is an advantageous and extremely economical solution, especially in interactive radio-television applications. As a matter of fact, most decoders are powered by the public electric network; the network therefore already exists, and can be used as means of transmission for data typically related to interactive applications in communication with a service centre, which may even be located at a great distance from the building.

Moreover, the present invention also allows to monitor statistical data related to a large number of radio-television viewers: an always active and certain connection of all decoders, in fact, allows the monitoring in real time of all interactive decoders being present on the territory, i.e. with no need to await a predetermined time. The monitoring takes place without any intervention by the radio-television viewer, except for entering (only once) his/her personal data and declaring (at each session) his/her identity, if such information is not available otherwise, e.g. by means of an electronic card containing personal data.

A devices for the reception of television signal adapted to receive and transmit data over its electric supply line such as the one according to the present invention may also be put in communication with the domestic electricity meter. The present invention also concerns such an application, which is independent of both the communication between the devices for the reception of television signal and the television service centre and the communication between the domestic meter and the electric power supply company. Further objects, features and advantages of the present invention will become apparent from the following detailed description and the annexed drawings.

For a better understanding of the invention, some embodiments of the same will now be described by way of non-limiting example with reference to the annexed drawings, wherein:

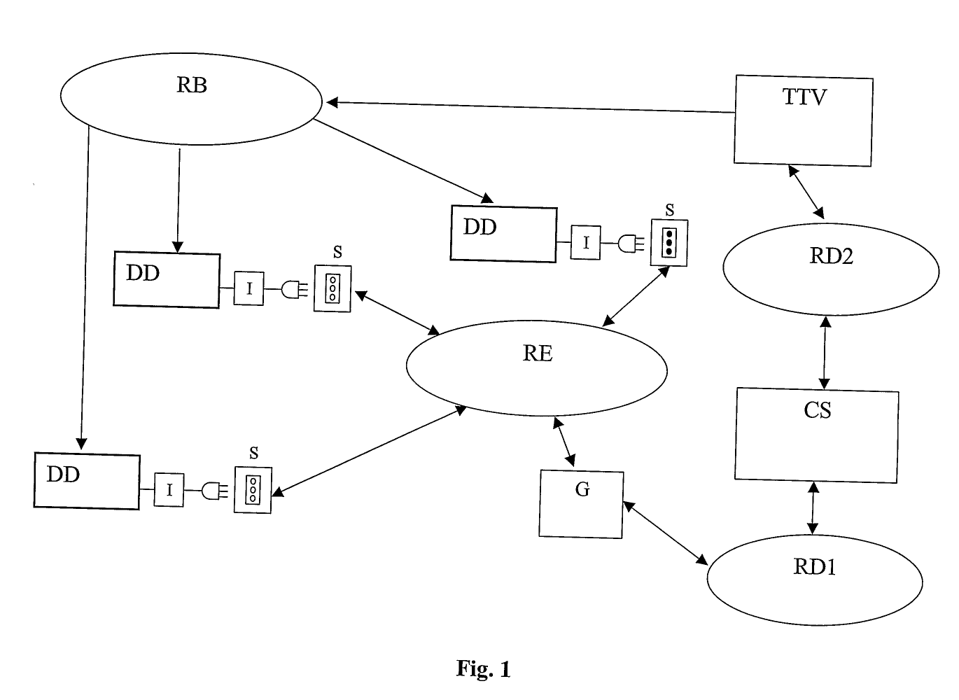

FIG. 1 shows a diagram of a system according to the present invention,

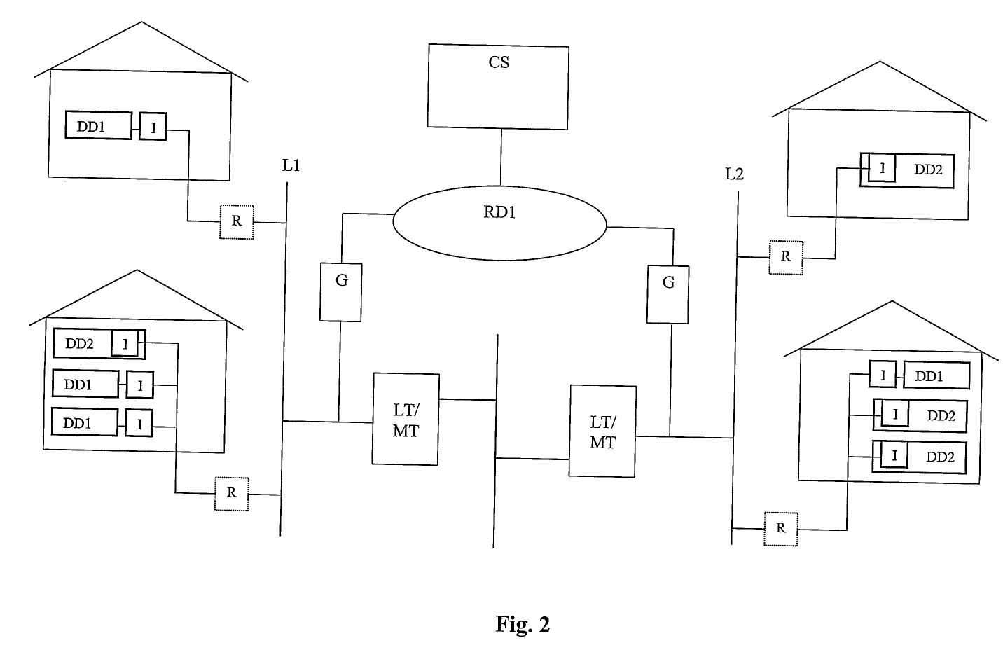

FIG. 2 shows a particular embodiment example of the system of FIG. 1,

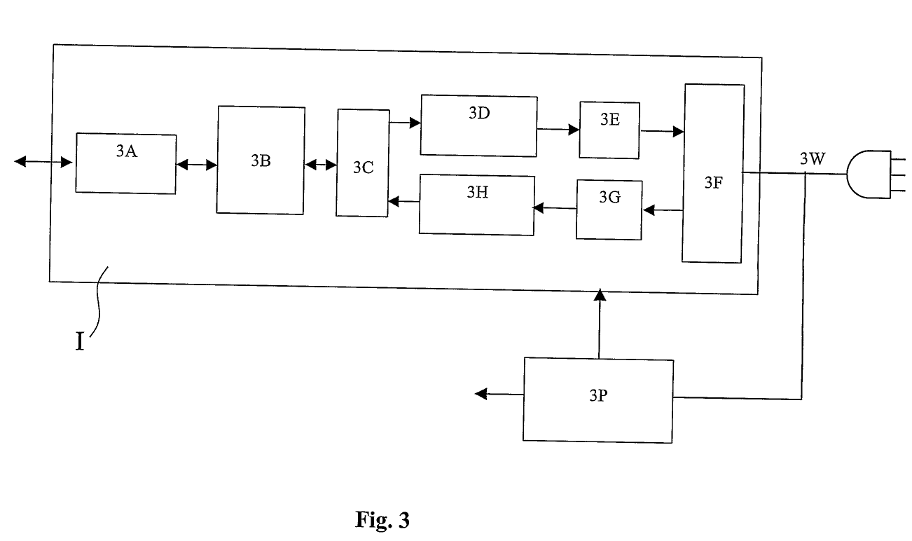

FIG. 3 shows a diagram of a possible implementation of the decoder-electric line interface designated I in FIG. 2, and

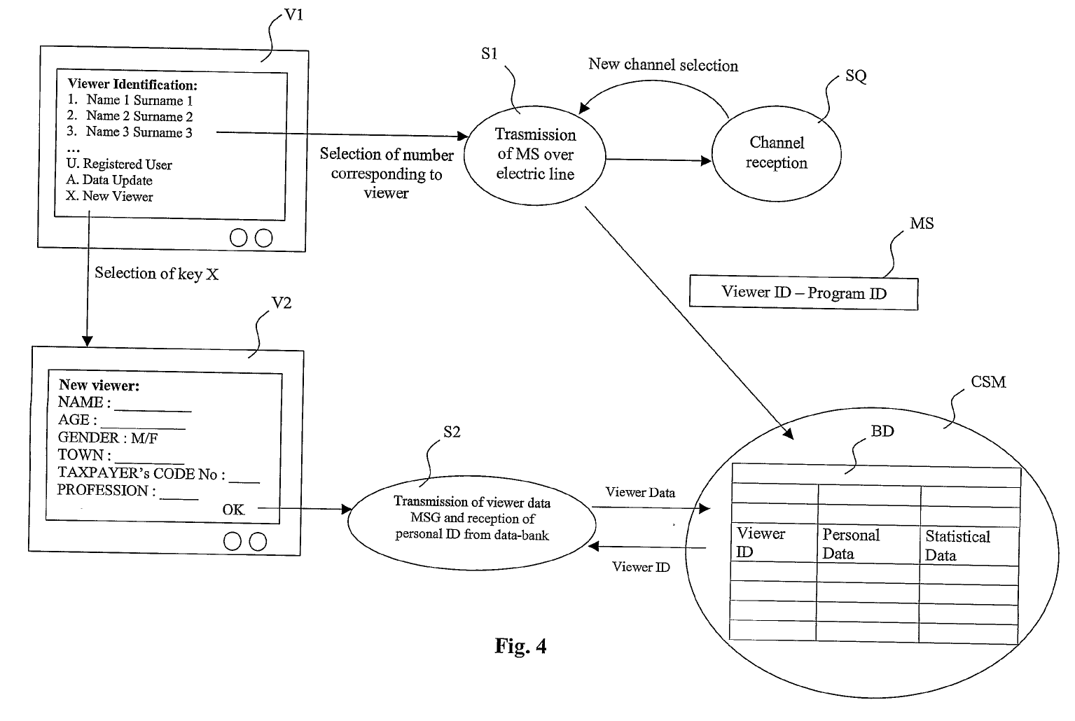

FIG. 4 shows an intuitive example of a particular application which allows to monitor statistical data related to preferences of the viewers.

The system of FIG. 1 in general is made up of any number of decoders DD adapted to receive and decode audio-video digital signals, as well as to implement interactive applications, e.g. complying with the DVB-MHP [Multimedia Home Platform] Standard (ETSI ES 201 812 Standard), which decoders are spread around the territory in the various houses of the users.

MHP is an open Standard for multimedia and interactivity management; it defines a software interface which allows any interactive application to use the functionalities available in the decoder.

The decoders DD receive the radio-television signals in a known way from the broadcast network RB, and interact with a remote service centre CS through a set of communication channels consisting, at least for a short distance, of the electric network RE, whereto the decoders are connected through the normal electric socket S and the device I, which represents the interface allowing the decoder to send and receive data over the electric network.

At a point of the electric network, conveniently chosen to minimize the complexity and costs of the system, the data can be extracted and forwarded over different media (optical fiber, telephone cable, electromagnetic waves, etc.) and different networks RD1 (Internet, PSTN fixed telephony networks, or mobile telephony networks such as the well-known GSM and UTMS networks), in order to reach the service centre CS.

The block G represents the interface device (“gateway”) between the electric network RE and the data network RD1, and it receives the data coming from the DDs through RE and forwards it over the network RD1, and vice versa, by appropriately converting the data format and the communication protocol, in those cases where RD1 and RE are incompatible networks.

The service centre CS further processes this data and, if required, sends reply data to the decoder over RD1; G receives said reply and forwards it to the destination decoder through RE, thus using the electric network RE as a bidirectional channel. CS may also have to control the provider's radio-television transmitter TTV to forward the message over the broadcast network RB, by adding it to the normal radio-television flow, so that the contents can be accessed only by authorized people.

In this latter case, the service centre must be able to communicate with TTV, e.g. over the data network RD2.

FIG. 2 shows a particular embodiment of the system of FIG. 1.

The decoders powered by the same low-voltage electric subnet (the illustration shows two subnets L1 and L2) share said subnet to transmit and receive data. The interface I allows to couple the decoder to the network, and may consist, for instance, of an external device (as is the case of the decoders DD1 in FIG. 2) or be an integral part of the decoder itself (as is the case of the decoders DD2 in FIG. 2); this device will be described more in detail in the following.

As known, low-voltage electric lines represent a noisy and adverse environment for a proper transmission of data; therefore, if necessary, signal relays R may be placed along such a line in order to find a remedy for the high attenuation which is typical of this means. For example, it may be useful to provide each house with a relay node, which may additionally be intelligent and operate as an interface between the building and the rest of the low-voltage network. In this case, by positioning the relay near the building it will be possible to reduce at every single decoder the transmission power required.

The risk of a collision of data carried over the subnet is avoided by implementing known multiplexing methods, such as frequency or code division and/or appropriate procedures, e.g. known collision control systems (like Carrier Sense Multiple Access with Collision Detection [CSMA/CD], as according to the IEEE 802.3 Standard) or other known protocols.

Since electric transformers LT/MT are present along the electric network for medium-to-low voltage conversion, which represent a barrier to the passage of the high-frequency signal, the signal must be extracted from the low-voltage lines at these transformers by the “gateway” device G and sent over a different medium, such as optical fiber and telephone cables, or else by air through radio links or antennas, over specific or existing networks RD1 (terrestrial or satellite networks, already in place or under construction).

According to an advantageous solution, G is a device which provides communication between the electric network and the existing Internet network, and said electric network is used as means of transmission for data related to interactive applications executed by the decoders.

As concerns decoders adapted to execute applications complying with the MHP Standard, it is known that said Standard provides for the existence of an advanced profile, with the possibility of accessing Internet services, like web navigation, and of using security protocols already developed for that network.

The above-described system provides the viewer with a permanent connection to the network, without the need to establish a specific connection for each session, thus making the return channel of the decoder available right from the switch on operation, with the possibility of receiving information at any time.

FIG. 3 shows an interface device between the decoder and the network, designated I in FIGS. 1 and 2; this device may be internal to the decoder or else connected to the same by means of a suitable short-distance communication system (serial cable, parallel cable, telephone duplex cable, etc.); the block 3A represents an input/output interface for the communication with the decoder.

A device 3B suitably processes the digital data received and to be transmitted; it may be advantageous to implement a communication protocol suited to electric lines (e.g. LONTALK, see the ANSI EIA/CEA-709.1-A-1999 Standard), which allows to prevent any data collisions over the network and activates a retransmission mechanism in the event of data losses, considering the unreliability of the channel. Such a device typically consists of a microprocessor, with a RAM memory adapted to the implementation of the protocol and a ROM or EPROM memory for permanent data, e.g. program instructions. It may be necessary to use a digital signal processing device 3C having noise elimination functions, distortion correction functions, as well as known error correction methods in order to increase communication reliability (convolutional codes, Reed-Solomon codes, etc.).

3D and 3H represent interfaces between the digital and analog portions of the device I, wherein the signal is modulated and demodulated, respectively; known techniques like “dual carrier frequency” and spread spectrum (see U.S. Pat. No. 4,979,183 on this matter) may be used for this purpose; frequencies must be chosen carefully, observing the Standards in force (FCC in the US, CENELEC in Europe), so as to prevent any electromagnetic waves generated by the electric cables from interfering with other communication systems by air.

3E and 3G represent physical interfaces toward the electric network; in particular, 3E is an amplifier designed to provide the remote receiver with an adequate signal/noise ratio, whereas 3G is a “front/end” which amplifies the received signal.

3F represents a coupling device; in particular, it is a band-pass filter which allows signals to pass on specific frequencies only, thereby separating the data signal from the supply signal, whose frequency is normally much lower, thus eliminating any noise being present on frequencies outside the working band. 3W is an electric cable connected to both the filter 3F and the normal decoder power supply, designated 3P in FIG. 3.

A sector which would benefit considerably from using the above-described system is the monitoring of video-radio audience preferences for statistical purposes.

The always active connection ensured by the communication over an electric network allows to carry out real-time monitoring, i.e. with no need to wait for the moment preset for downloading the data, of basically all decoders in the area which are adapted to implement applications.

FIG. 4 shows an intuitive example of a particular application which allows to monitor statistical data related to the preferences of the viewers.

The user participating in the statistical survey can enter his/her personal information by using a remote control or a keyboard upon request of a specific application, hereafter referred to as A1, stored or plugged in the memory of the decoder, e.g. complying with the MHP Standard.

In this figure, V2 indicates possible a screen which may be displayed when the viewer enters his/her personal information. The screen lists the following items:
New viewer
NAME
AGE
GENDER: M/F (“M” for Male or “F” for Female)
TOWN
TAXPAYER'S CODE NUMBER
PROFESSION

CSM indicates a service centre like the one designated CS in FIGS. 1 and 2, or a particular service centre dedicated to the monitoring activity.

The application A1 then transmits the personal data to the service centre CSM and receives a numerical code identifying the viewer in order to allow the provider to store the information related to all viewers in a databank BD, which can be updated dynamically. This operation, conceptually represented by S2 in the illustration, corresponds to the transmission of a MSG, i.e. a message, containing the data of the viewer, and to the reception of a personal ID (i.e. identification code) from the databank. The ID received from the databank may not necessarily match with the ID stored in the databank. For instance, the received code may just be a portion of the stored code, and be univocal only for the people associated with the location where the decoder (1=father, 2=mother, . . . ) is installed; in this case, during the statistical survey the decoder may send to the service centre a code corresponding to a combination of the code received from the databank and a specific code of the decoder itself; logically, the databank will be in such a way as to take into account the fact that several decoders used by the same people may be installed in the same place.

The databank BD is represented in the illustration by three data columns corresponding to the viewer's ID, to the personal data and the statistical data, respectively.

The application A1 allows the viewer to consult and subsequently modify his/her personal data.

A easier procedure for entering the viewer's personal data employs electronic cards in which such data has already been memorized, if the decoder is provided with card reader means; A1 obtains the data by reading it from the electronic card, so that the viewer merely has to enter additional data, if required.

The identification code of the viewer in the databank BD may consist, for example, of a numerical code assigned to the viewer at the first login or of a univocal personal piece of information stored in the memory of the electronic card, such as the card identification number or the taxpayer's code number of the user.

The service centre CSM may allow to enter new users, to delete old users, or to update personal data in its databank BD. The information needed for statistical purposes, such as programs watched at different times of the day, preferences, etc., will thus be associated with every viewer in the data bank BD.

The service centre CSM is normally provided with an operating system (Unix, Windows, Linux, etc.) and may use one of the several common application programs for information management, which offer the possibility of managing, accessing and modifying an electronic file (SQL, Oracle, etc.).

Every personal data communication should take place through a data coding system, e.g. the public-key system (in this regard, see the U.S. Pat. No. 4,218,582) among other known systems.

Every time the decoder fitted with means for the collection of statistical data is turned on, it must activate a simple identification procedure in order to identify the current viewer, e.g. by requiring a number to be entered through the numerical keypad of the remote control or by the selection of a name among those listed on the screen, or else by reading the data stored in a personal electronic card, when possible.

In the illustration, V1 indicates an example of screen which may be displayed when the viewer accesses the decoder. The screen lists the following items:

### Viewer Identification

### 1. 1. Name1 Surname1

### 2. 2. Name2 Surname2

### 3. 3. Name3 Surname3

### U. Registered User

A. Data Update
X. New Viewer

During the normal “Channel Reception”, i.e. the reception of an audio-video service, the decoder is in the state conceptually represented by SQ in the illustration; as the viewer commands the decoder to tune to a particular program, the decoder will start a simple application A2 dedicated to the transmission over the electric line of the message MS containing the viewer's identification code (“Viewer ID” in the illustration), and the code of the chosen program (“Program ID” in the illustration) to the service centre (state S1 in the illustration) over the electric line.

To avoid the transmission of negligible data, so as to limit the amount of data to be transmitted, the decoder may send the message MS only if the viewer has remained tuned to the same channel for at least a preset minimum time.

A registered user in the databank may advantageously be identified, when using different decoders, without having to re-enter all the data; a single, univocal information may suffice, such as the user's identification number or taxpayer's code number; this is no longer a problem when the identification means is a personal electronic card, because the identification takes place by reading the information stored in the card.

A possible expedient may be useful when using the system described in FIGS. 1 and 2 for television polls; the applications used for this purpose, which are generally supplied by the service providers themselves and transmitted together with the audio-video signal, allow the viewer to express his/her own ideas or preferences regarding characters, sports events, society events, etc.

During the program, the viewer is often invited to interact at precise moments; this causes an information overload on the network, with several data collisions and management problems suffered by the service centre. This problem can be solved, in the present invention, by temporarily storing the data in the decoder memory for a random time period, after which the decoder can try to access the network.

In this way, the data transmissions from the users are distributed over a time interval being long enough to reduce the risk of a collision and to allow for the management of a large quantity of data.

Another application of the system according to the present invention consists in the possibility of avoiding and/or identifying any frauds when the decoders operate through payment systems activated by electronic cards or similar tools.

In fact, since the decoder is constantly connected to the service centre, with which it can exchange a lot of data, even when not entered directly by the user, the service centre can create its own databank including all the users generally using the decoders. Through this databank it is possible to check at any time whether a user connected to the service is an authorized user or not (expired subscription, cloned electronic card, etc.) and, if necessary, to take appropriate actions.

Such an action may be the transmission of a code which locks the equipment definitively (until it is unlocked by a suitable technical service centre), or contacting the hacker and taking measures as considered appropriate to a case of expired subscription or cloned card.

In order to implement this anti-fraud system, the interface I should advantageously be contained within the decoder (DD2 in FIG. 2), so that it cannot be bypassed by the user and it works without anyone knowing, just by the fact that the connection cable to the electric network is plugged in.

The connection to the electric network used as means for transmitting data offers another interesting possibility to the user of the digital decoder, since it improves and customizes the system for reading the electricity meter.

As known, the latest-generation intelligent electricity meters can be read and controlled by electric utility companies, who exploit the low-voltage electric network as a means for reading the meters automatically and remotely, generally by using frequencies being much higher than the mains frequency.

A system like the one illustrated in FIGS. 1 and 2 implements a point-to-point connection between the meter and the decoder; by developing an application complying with the MHP Standard, for example, the decoder owner can be allowed to check his/her electric consumptions, send messages and/or data to the company, and carry out statistical and trend surveys related to his/her own electric consumptions, etc. from the radio-television station.

An example of an interactive application complying with the MHP Standard may be the following: the decoder owner sends a request to his/her electricity meter, which replies by providing, over the same local electric line, the useful information requested by the user, e.g. average and instantaneous consumption, costs and current rate.

Such an application, being interactive by nature, also gives the user the possibility of sending requests to the utility company, e.g. a rate change request or a malfunction notification.

The requests may also be addressed directly to the meter, which automatically will forward them to the company over the electric line by using specific protocols and frequencies. Clearly, these particular applications absolutely require that the decoder uses the same frequencies and communication protocol as those used by the electricity meter for sending and receiving data related to said applications over the electric line. The above-described embodiments of the present invention are merely exemplificative, as there may be other embodiment examples of the principles of the present invention.

1-30. (canceled)

31. A system for establishing a connection between a service center and a plurality of devices for reception of a radio television signal, wherein the connection is realized by using an electric supply network, wherein the devices for the reception are powered by the electric supply network, wherein the electric supply network is set up as a local area network of devices for the reception of the radio television signal.

32. A system according to claim 31, wherein the electric supply network is a subnet of a public electric supply network.

33. A system according to claim 31, wherein the devices for the reception are configured to execute interactive software applications, the applications being stored in or downloaded in respective memories of the devices for the reception and configured to allow the connection between devices for the reception and a service center, the connection being a bidirectional connection.

34. A system according to claim 33, wherein the connection carries out collection and/or exchange of data.

35. A system according to claim 31, wherein the connection is realized partly through a low-voltage electric supply network and partly through a network of a different type.

36. A system according to claim 31, wherein the devices for the reception are powered by a same subnet of a public electric supply network.

37. A system according to claim 36, wherein the connection provides for transmission of data by the devices for the reception over the subnet and for detection and/or prevention of data collisions over the subnet through a communication method.

38. A system according to claim 37, wherein the data to be transmitted is stored temporarily in a memory of the device for the reception for a random time period and are afterward transmitted.

39. A system according to claim 31, for statistical surveys on samples of viewers using devices for the reception of the radio television signal, the devices for the reception comprising means for sending viewer-related data to the service center in real time through an electric supply network and implementing procedures for identifying the viewer and for transmitting personal data of the viewer to the service center.

40. A system according to claim 39, wherein the identification and/or transmission procedures are carried out entirely or partially by reading personal data stored in a personal electronic card.

41. A system according to claim 40, wherein, for detecting any unauthorized use of the device for the reception, the service center comprises a databank created by receiving the personal data, which is then compared with personal data of authorized users, and both the personal data and an interface configured to transmit the personal data over the electric network are contained within the devices for the reception.

42. A system according to claim 39, wherein the identification procedure takes place in compliance with MHP Standard.

43. A device for reception of a radio television signal comprising:
means for establishing a connection to a service center through an electric supply network; and
means for creating a local area network (LAN) by using an electric supply line of the electric supply network as a connection medium.

44. A device according to claim 43, further comprising means for storing interactive software applications and means for executing interactive software applications, the applications configured to allow establishing a connection to the service center, the connection being a bidirectional connection.

45. A device according to claim 44, wherein the connection carries out collection and/or exchange of data.

46. A device according to claim 43, further comprising means for transmitting data over the electric supply line and means for detecting and/or avoiding any data collisions over the electric supply line.

47. A device according to claim 43, further comprising means for executing:
temporary storage of the data to be sent in a memory of the device for the reception or in a memory of a network interface for a random time period, followed by
transmission of the data temporarily stored in the memory.

48. A device according to claim 43, further comprising means for implementing applications complying with the MHP Standard.

49. A device according to claim 48, further comprising means for transmitting in real-time the data related to the viewer, over an electric supply line of the viewer, to the service center.

50. A device according to claim 49, further comprising means for implementing procedures for identifying the viewer and for transmitting personal data of the viewer to the service center.

51. A device according to claim 50, wherein the means for implementing procedures for the identification of the viewer and the means for transmitting data are contained within a same device.

52. A device according to claim 50, further comprising means for reading data from a personal electronic card, which means are configured to be used in the identification and/or transmission procedures.

53. A television set comprising a device for reception of a radio television signal according to claim 43.

54. A system for establishing a connection between a service center and a plurality of devices for reception of the radio television signal according to claim 49, a device for reception of the radio television signal, and a television set.

55. A system comprising:
at least one device for reception of a radio television signal; and
at least one domestic electricity meter,
the device and the meter being connected to a same domestic electric supply network, wherein there is exchange of data between the meter and the device.

56. A system according to claim 53, wherein the device is configured to execute software applications complying with MHP Standard and comprises a memory section storing a software application for reading and/or controlling the meter.

57. A system according to claim 55, wherein the device is configured to execute software applications complying with MHP Standard and comprises a memory section storing a software application for transmitting and/or receiving messages to/from a public electric utility company through the meter.

58. A device for reception of a radio television signal, configured to be connected to a domestic electric supply network, the network being associated with a domestic electricity meter, comprising means for exchanging data with the meter.

59. A device according to claim 58, configured to execute software applications complying with MHP Standard and comprising a memory section storing a software application for reading and/or controlling the meter.

60. A device according to claim 58, configured to execute software applications complying with MHP Standard and comprising a memory section storing a software application for transmitting and/or receiving messages to/from the public electric utility company through the meter.
